(19) United States
(12) Patent Application Publication
(10) Pub. No.: US 2009/0019495 A1
(43) Pub. Date: Jan. 15, 2009

(54) Reservation system of television program guide using internet and reservation method thereof

(75) Inventor: Soo-Woong Kim, Seoul (KR)

Correspondence Address: Jefferson IP Law, LLP, 1730 M Street, NW, Suite 807, Washington, DC, 20036, US

(73) Assignee: ALTICAST CO., LTD., Seoul (KR)

(21) Appl. No.: 12/159,936

(22) PCT Filed: Dec. 28, 2006
(86) PCT No.: PCT/KR06/05800

§ 371 Date: Jul. 2, 2008

(30) Foreign Application Priority Data
Jan. 6, 2006 (KR) 10-2006-0001824

(51) Int. Cl. H04N 5/445; H04N 7/173

(52) U.S. Cl. 725/58; 725/110; 725/114

(57) ABSTRACT

A television program reservation method is provided for allowing a user to reserve programs at a website and down-load reservation information within a set-top box through Internet such that the reserved program can be played by the set-top box. The program reservation system for a broadcast system includes a subscriber terminal having a web browser for accessing Internet; an electronic program guide management server for managing electronic program guide provided by an electronic data provision server and electronic data, building a database of reservation information with programs registered by a subscriber, retrieving and transmitting the reservation information to the subscriber terminal when requested; and a set-top box for requesting reservation information and storing the reservation information received from the electronic program guide management server, such that the reservation information reserved through Internet is received and stored by the set-top box.

### TECHNICAL FIELD

The present invention relates to a program guide reservation method and, in particular, to a television program reservation method that allows a user to reserve programs at a website and download reservation information within a set-top box through Internet such that the reserved program can be played by the set-top box.

### BACKGROUND ART

Typically, a digital broadcasting system provides Electronic Program Guide (EPG) allowing a viewer to navigate, select, or discover content by time, title, channel, genre, etc.

An EPG can be provided by means of a set-top box or through a web site of a program information provider.

In the former method, the EPG contains program information for 1 day or 3 days for broadcast channels in consideration of influence to a broadcast transmission bandwidth, and such a small amount of program information has not satisfied user's desires. This problem cannot not be solved until a broadcast bandwidth assigned for the broadcast system increases.

Also, the conventional set-top box has a limit to retrieving and reserving a target program and requires cumbersome and time consuming manipulation.

In the latter method, the program guide provider can provide large amount of program information through its web site. However, the latter method does not enable a viewer to reserve a playback of a program on a television, thereby helpless for convenient program reservation.

### DISCLOSURE OF INVENTION

Technical Problem

The present invention has been made in an effort to solve the above problems, and it is an object of the present invention to provide a program reservation system and method for a digital broadcast system that are capable of allowing a viewer to reserve a program to be played on a television through a website.

Technical Solution

In accordance with an aspect of the present invention, the above and other objects are accomplished by a program reservation system for a broadcast system. The program reservation system includes a subscriber terminal having a web browser for accessing Internet; an electronic program guide management server for managing electronic program guide provided by an electronic data provision server and electronic data, building a database of reservation information with programs registered by a subscriber, retrieving and transmitting the reservation information to the subscriber terminal when requested; and a set-top box for requesting reservation information and storing the reservation information received from the electronic program guide management server, such that the reservation information reserved through Internet is received and stored by the set-top box.

Preferably, the electronic program guide management server includes a web server for allowing a subscriber to access the program; a database server for managing registered reservation information, program data, channel data, and contents provider data; and a core server for retrieving, when a reservation information request is received from the subscriber terminal, reservation information from the data base server and transmitting the retrieved reservation information to the subscriber terminal.

Preferably, the subscriber terminal includes a set-top box controller for periodically generating and transmitting the reservation information request; and a storage for storing the reservation information received from the electronic program guide management server in response to the reservation request.

Preferably, the set-top box stores a transmission time interval for transmitting the reservation information request and the set-top box controller transmits the reservation information request in response with the transmission time interval.

Preferably, the reservation information includes a subscriber ID, program IDs, channel IDs, program start times, and program end times.

In accordance with another aspect of the present invention, the above and other objects are accomplished by a television program guide reservation method for a broadcast system including a subscriber terminal and an electronic program guide management server. The television program guide reservation method includes accessing, at the subscriber terminal, a website managed by the electronic program guide management server using a web browser; searching a target program in the website; registering, if a target program is found, the target program as reservation information; generating, at the electronic program guide management server, a database for managing the reservation information; transmitting, at the subscriber terminal, a reservation information request; transmitting, at the electronic program guide management server, the reservation information in response to the reservation information request; storing, at the subscriber terminal, the reservation information received from the electronic program guide management server.

Preferably, the television program guide reservation method further includes checking, at the subscriber terminal, the stored reservation information.

Preferably, the television program guide reservation method further includes starting playback of the program registered in the reservation information.

Preferably, the database stores and manages program data provided by an electronic program guide data provision server, channel data provided by an electronic program guide server, reservation information, and contents data.

Preferably, transmitting a reservation information request includes storing a transmission time interval for periodically transmitting the reservation information request; and transmitting the reservation information request with reference to the transmission time interval.

Preferably, transmitting the reservation information includes retrieving reservation information corresponding to the reservation information request; collecting reservation information having a subscriber ID carried by the reservation information request; and sending the collected reservation information to the subscriber terminal.

Advantageous Effects

As described above, a program reservation system and method of the present invention enable a subscriber to reserve programs to be played at a website and information on the reserved programs is transmitted to a subscriber's set-top box, thereby increasing efficient reservation and user convenience.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating a configuration of a program reservation system of a digital broadcast system according to an embodiment of the present invention;

FIG. 2 is a flowchart illustrating a program reservation method for a digital broadcast system according to an embodiment of the present invention;

FIG. 3 is a drawing illustrating a format of program data used in a program reservation method according to an embodiment of the present invention;

FIG. 4 is a drawing illustrating a format of channel data used in a program reservation method according to an embodiment of the present invention;

FIG. 5 is a drawing illustrating a format of reservation information used in a program reservation method according to an embodiment of the present invention; and

FIG. 6 is a block diagram illustrating a procedure for transmitting reservation information in a program reservation method according to an embodiment of the present invention.

### MODE FOR THE INVENTION

Exemplary embodiments of the present invention are described with reference to the accompanying drawings in detail. The same reference numbers will be used throughout the drawings to refer to the same or like parts. Detailed descriptions of well-known functions and structures incorporated herein may be omitted to avoid obscuring the subject matter of the present invention.

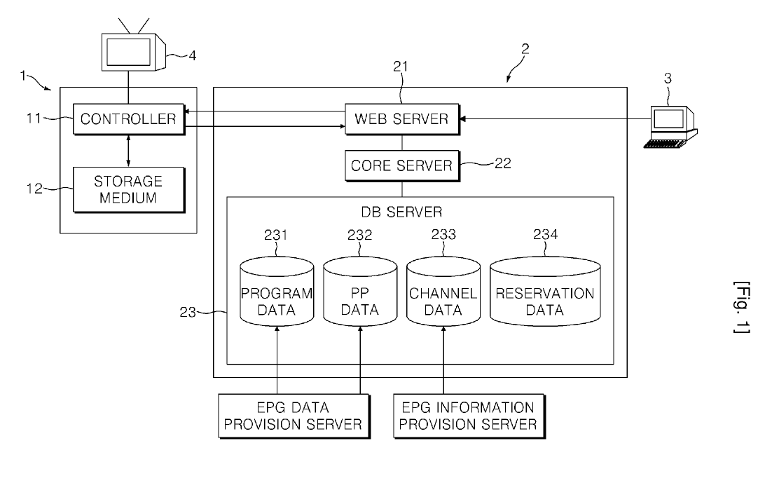

FIG. 1 is a block diagram illustrating a configuration of a program reservation system of a digital broadcast system according to an embodiment of the present invention.

Referring to FIG. 1, the program reservation includes an EPG management server 2 and a user premise set top box 1.

The EPG management server 2 is a web service system provided by a platform operator. The EPG management server 2 includes a web server 21 providing a webpage allowing a subscriber to access the EPG management server 2; a database (DB) server 23 for managing program data 231, program provider (PP) data 232, channel data 233, and reservation data received from an EPG data provision server and EPG server of a broadcast station; and a core server for registering a program selected by a user as the reservation information 234 and requesting the DB server 23 to transmit the reservation information 234 to the set-top box 1 when requested.

The set-top box includes a controller 11 for periodically requesting the reservation data to the EPG management server 2 and a storage 12 for storing the reservation data.

The storage 12 can be any of random access memory (RAM), nonvolatile RAM (NVRAM), flash memory, etc. In a case using a volatile memory, an additional nonvolatile memory such as flash memory should be used for backup of important information.

The storage 12 can store reservation information registered in accordance with the conventional EPG received a broadcast station as well as the Internet-based reservation information in accordance with the present invention.

The controller 11 controls general operations of the set top box 1, executes applications, and displays programs on the basis of the reservation information.

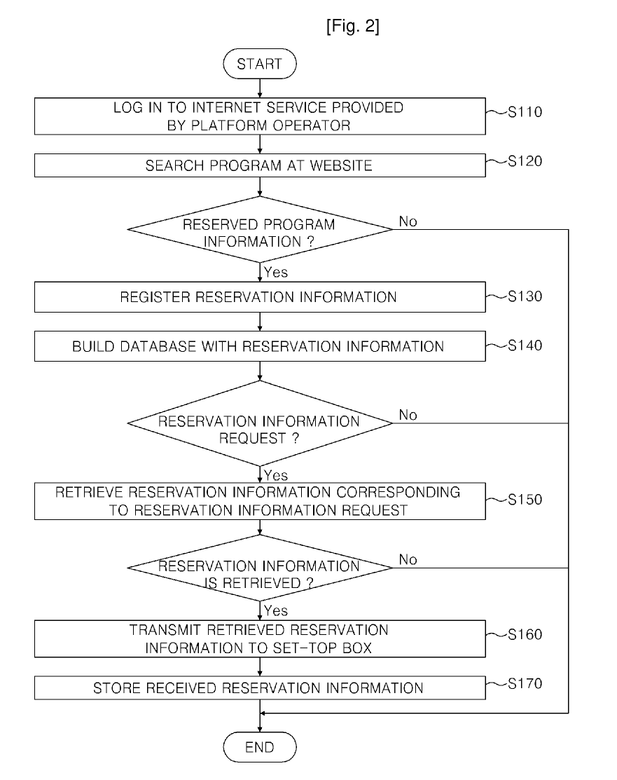

FIG. 2 is a flowchart illustrating a program reservation method for a digital broadcast system according to an embodiment of the present invention.

A platform operator obtains program data from the EPG data provision server of a program provider and EPG information from the EPG server of a broadcast station. The program data and EPG information are managed by the DB server 23. The platform operator represents developers building web platforms for providing web services.

The platform operator provides the information obtained from the EPG data provision server and the EPG server in the form of a web service.

Referring to FIG. 2, a subscriber accesses a website provided by the platform operator through a login process at step S110.

The subscriber can access the website using an Internet-enabled terminal by means of a web browser and a connection between the internet-enable terminal and the EPG management server can be established through at least one or combinations of wired or wireless networks such as PSTN, dedicated Internet line, ISDN, cellular network, PCS network, microwave network, and satellite network.

The web server 21 identifies the subscriber through the login process with a subscriber ID and password. The subscriber ID is embedded in subscriber's set top box. Every set box has a unique subscriber ID such that the subscriber can register a set box using its subscriber ID.

After login, the subscriber navigates or searches a target program through an EPG webpage provided by the platform operator at step S120. The program search can be performed by title, channel, director name, actor name, production company, and plot.

If the target program is retrieved through the navigation or search process, the program is highlighted. If the program is selected by the subscriber, the core server 22 registers the subscriber ID and reservation information 234 including program ID, channel ID, start time, and end time of the target program at step S130. The reservation information 234 is stored in the form of a database and managed by the DB server 23 at step S140.

If there is no target program, the subscriber may log out and terminate Internet connection.

The subscriber ID is used for identifying the subscriber's set-top box 1, the program ID is used for checking the reserved program, and the channel ID is used for checking the channel on which the program is broadcasted.

The set-top box 1 accesses the EPG management server 2 so as to periodically request the reservation information, and the core server 22 of the EPG management server 2 checks whether the reservation information exists by retrieving the reservation information of the set-top box 1 in the DB server 23 in response to the reservation information request at step S150.

Since the set-top box has an ID card having a unique ID which is used for identifying the subscriber, the core server 22 determines whether the subscriber ID is a registered by comparing the subscriber ID with the ID registered in the DB server 23. If the subscriber ID is a registered one, the core server 22 transmits the reservation information 234 to the set-top box 1 at step S160.

The reservation information is downloaded and stored in the storage of the set-top box at step S170.

The program reservation method is described hereinafter in more detail.

The EPG management server 2 obtains the program data from the EPG data provider, PP data from the EPG data provision server, and EPG information from the EPG server of the broadcast station.

The data are received in the form of XML and the data is input by a daemon-assisted auto matic transfer method or a webpage-based upload method.

In the daemon-assisted auto matic transfer method, the EPG data provider or the broadcast station transmits the data periodically or when the program is modified. That is, the EPG data provider program transmits the data to the EPG management server using a web service such as http/https, FTP, or socket.

In the webpage based file upload method, the EPG data provider generates an EPG information file and provides the file to the EPG management server through a file upload page.

The program data 231 includes a program provider ID (PPID), program ID, program title, program description, start and end times, and other program-related information.

The PPID is an ID for identifying a program content provider, and the program related information includes an age limit, actor/actress, producer, plot, etc.

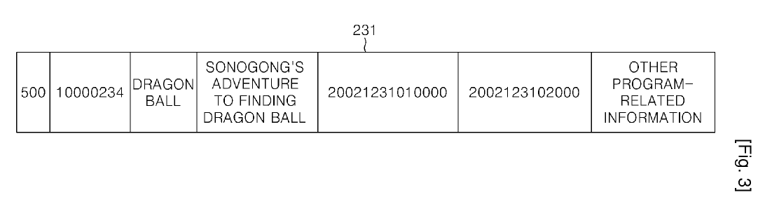

FIG. 3 is a drawing illustrating a format of program data used in a program reservation method according to an embodiment of the present invention.

Referring to FIG. 3, the program data 231 includes a PPID “500” a program ID “10000234” a program title “dragon ball”, a program plot “Sonogong's adventure for finding dragon ball”, start time “20021231010000”,and end time “20021231020000”. The program data can further include other program-related information.

The PP data includes PPID, PP name, PP description, and other PP-related data.

The channel data 233 is provided by the EPG server, and the channel data includes a channel ID, PPID, channel number, channel description, and other channel-related information. The other channel-related information includes channel package information.

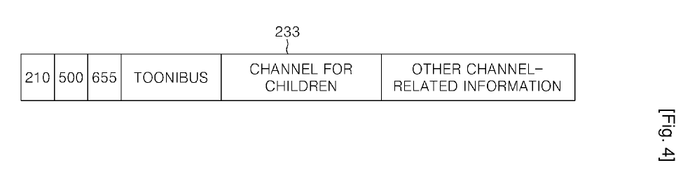

FIG. 4 is a drawing illustrating a format of channel data used in a program reservation method according to an embodiment of the present invention.

Referring to FIG. 4, the channel data includes a channel ID “210”, a PPID “500”, a program ID “655”, a channel name “toonibus”, a channel description “channel for children”,and other channel-related information.

The program data 231 and channel data 233 are stored in the form of a database.

The subscriber searches a program using a web browser and reserves the searched program. The reserved program is registered as the reservation information 234.

The reservation information 234 includes a subscriber ID, a program ID, a channel ID, a start time, an end time, etc. The subscriber ID and the program ID are most important information for retrieving the reservation information.

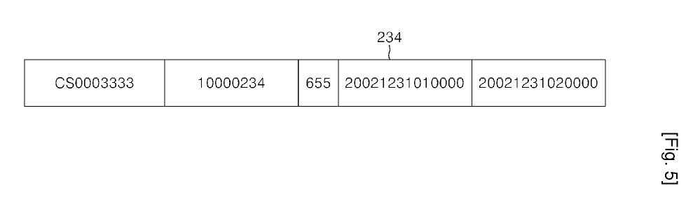

FIG. 5 is a drawing illustrating a format of reservation information used in a program reservation method according to an embodiment of the present invention.

Referring to FIG. 5, the reservation information includes a subscriber ID “CS0003333”, a program ID “10000234”, a channel ID “655”, a start time “20021231010000”, and an end time “20021231020000”. The reservation information can include other reservation-related information.

If such reservation information 234 is registered, the DB server stores the reservation information 234 in the form of a database.

The set-top box 1 periodically transmits a reservation information request message the reservation information to the EPG management server 2 for updating a duplicate of the reservation information stored in the set-top box 1.

The transmission interval of the reservation information request message can be adjusted. The set-top box stores information on the update request transmission interval in the storage 12 such that the controller 11 transmits the reservation information request message to the EPG management server 2 with reference to the stored update request transmission interval. Upon receiving the reservation information request message, the EPG management server 2 retrieves the reservation information of the set-top box 1 and transmits the retrieved reservation information in response to the reservation information request message. In order to exchange the reservation information request message and the reservation information, typical TCP/IP socket and http/https schemes are used.

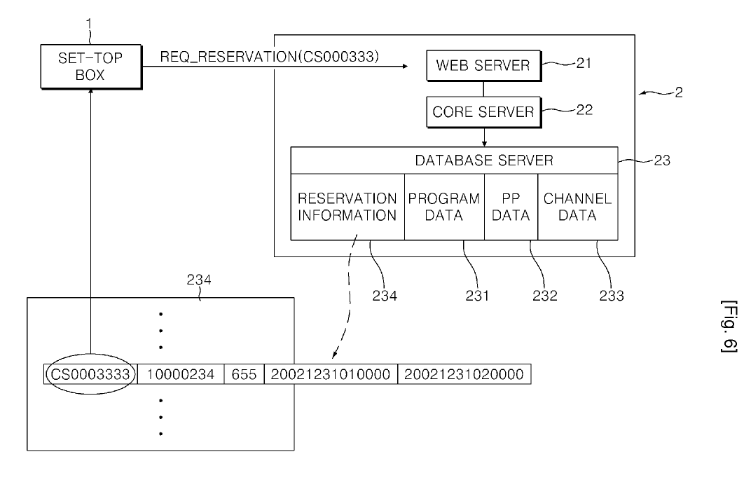

FIG. 6 is a block diagram illustrating a procedure for transmitting a reservation information in a program reservation method according to an embodiment of the present invention.

The controller 11 of the set-top box 1 transmits a reservation information request message in the form of REQ_RESERVATION(subscriber ID). The subscriber ID can be a set-top box ID.

Example: REQ_RESERVATION(CS000333)

If the reservation information request message is received, the core server 23 of the EPG management server 2 determines whether the reservation information registered for the set-top box. The reservation information is managed in the form of REQ_RESERVATION(reserved program list) and managed by the DB server 23. The reserved program list has a form (reserved data 1, reserved data 2, reserved data 3, . . . )

Example: REQ_RESERVATION((CS000333, 10000234, 655, 200212310230000, 200212310230000), . . . (CS000333, 10000267, 610, 20021231050000, 200212310553000)

Referring to FIG. 6, upon receiving the reservation information request message is received, the EPG management server 2 retrieves reservation information having the subscriber ID CS000333 from the reservation information database 234 of the DB server 23. If the reservation information is retrieved, the EPG management server 2 transmits the retrieved reservation information to the set top box 1.

Through the above-procedure, the reservation information stored in the storage 12 of the set-top box 1 is updated such that the set-top can maintain synchronization of the reservation information with the EPG management server 2.

As described above, a program reservation system and method of the present invention enable a subscriber to reserve programs to be played at a website and information on the reserved programs is transmitted to a subscriber's set-top box, thereby increasing efficient reservation and user convenience.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A program reservation system for a broadcast system, comprising:
a subscriber terminal having a web browser for accessing Internet;
an electronic program guide management server for managing electronic program guide provided by an electronic data provision server and electronic data, establishing a database of reservation information with programs registered by a subscriber, retrieving and transmitting the reservation information to the subscriber terminal when requested; and
a set-top box for requesting reservation information and storing the reservation information received from the electronic program guide management server, such that the reservation information reserved through Internet is received and stored by the set-top box.

2. The program reservation system of claim 1, wherein the electronic program guide management server comprises:
a web server for allowing a subscriber to access the program program;
a database server for managing registered reservation information, program data, channel data, and contents provider data; and
a core server for retrieving, when a reservation information request is received from the subscriber terminal, reservation information from the data base server and transmitting the retrieved reservation information to the subscriber terminal.

3. The program reservation system of claim 1, wherein subscriber terminal comprises: a set-top box controller for periodically generating and transmitting the reservation information request; and a storage for storing the reservation information received from the electronic program guide management server in response to the reservation request.

4. The program reservation system of any of claims 1 and 3, wherein the set-top box stores a transmission time interval for transmitting the reservation information request in the storage and the set-top box controller transmits the reservation information request to the electronic program guide management server at the transmission time interval stored in the storage.

5. The program reservation system of any of claims 1 and 2, wherein the reservation information includes a subscriber ID, program IDs, channel IDs, program start times, and program end times.

6. A television program guide reservation method for a broadcast system including a subscriber terminal and an electronic program guide management server, comprising:
accessing, at the subscriber terminal, a website managed by the electronic program guide management server using a web browser;
searching a target program in the website;
registering, if a target program is found, the target program as reservation information;
generating, at the electronic program guide management server, a database for managing the reservation information;
transmitting, at the subscriber terminal, a reservation information request;
transmitting, at the electronic program guide management server, the reservation information in response to the reservation information request; and
storing, at the subscriber terminal, the reservation information received from the electronic program guide management server.

7. The television program guide reservation method of claim 6, further comprising checking, at the subscriber terminal, the stored reservation information.

8. The television program guide reservation method of claim 6, further comprising starting playback of the program registered in the reservation information.

9. The television program guide reservation method of claim 6, wherein the database stores and manages program data provided by an electronic program guide data provision server, channel data provided by an electronic program guide server, reservation information, and contents data.

10. The television program guide reservation method of claim 6, wherein transmitting a reservation information request comprising:
storing a transmission time interval for periodically transmitting the reservation information request; and
transmitting the reservation information request with reference to the transmission time interval.

11. The television program guide reservation method of claim 6, wherein transmitting the reservation information comprises:
retrieving reservation information corresponding to the reservation information request;
collecting reservation information having a subscriber ID carried by the reservation information request; and
sending the collected reservation information to the subscriber terminal.
